(19) United States
(12) Patent Application Publication
(10) Pub. No.: US 2019/0264655 A1
(43) Pub. Date: Aug. 29, 2019

(54) CONVERSION OF MOVEABLE OFFSHORE DRILLING PLATFORMS TO A WIND TURBINE INSTALLATION UNIT

(71) Applicant: ZENTECH, INC., Houston, TX (US)

(72) Inventor: Ramesh MAINI, Houston, TX (US)

(21) Appl. No.: 16/284,415

(22) Filed: Feb. 25, 2019

Related U.S. Application Data
(60) Provisional application No. 62/654,961, filed on Apr. 9, 2018.
(60) Provisional application No. 62/636,690, filed on Feb. 28, 2018.

(51) Int. Cl. F03D 9/43; F03D 13/25

(52) U.S. Cl. CPC F03D 9/43; F03D 13/25

(57) ABSTRACT

The present disclosure generally relates to movable offshore platforms for installing wind turbines, and methods of forming the same. The movable offshore platforms are offshore platforms which were previously used in hydrocarbon production, such as jack-up units. The movable offshore platforms may be decommissioned and retrofitted with equipment for installing wind turbines. The movable offshore platforms may be American-made or otherwise Jones Act compliant. Methods of forming the same are also included.

### CROSS-REFERENCE TO RELATED APPLICATIONS

This application claims priority to U.S. Provisional Patent Applications No. 62/636,690, filed Feb. 28, 2018, and No. 62/654,961, filed Apr. 9, 2018, each of which are incorporated by reference in their entireties.

### BACKGROUND

### Field

Embodiments of the present disclosure generally relate to movable offshore platforms for installing wind turbines, and methods of forming the same.

### Description of the Related Art

Decommissioned offshore moveable platforms, including but not limited to moveable oil platforms, are often forgotten and allowed to go into a state of disrepair, or may be sunk to form artificial reefs. Occasionally, the decommissioned moveable oil platforms may be stripped for scrap. However, none of these outcomes utilize a decommissioned movable oil platform to full potential of the platform, especially considering the labor and engineering man-hours put into the erection of the platforms.

Therefore, there is a need for a new use of decommissioned moveable offshore oil platforms.

### SUMMARY

The present disclosure generally relates to movable offshore platforms for installing wind turbines, and methods of forming the same. The movable offshore platforms are offshore platforms which were previously used in hydrocarbon production, such as jack-up units. The movable offshore platforms may be decommissioned and retrofitted with equipment for installing wind turbines. The movable offshore platforms may be American-made or otherwise Jones Act compliant. Methods of forming the same are also included.

In one aspect, a method comprises converting hydrocarbon producing units to a wind turbine installation unit. The converting includes removing oil production equipment. Two hydrocarbon producing units are coupled to form a hull. A heavy lift crane is stalled on the hull.

In another aspect, a wind turbine installation method comprises converting a hydrocarbon producing unit to a wind turbine installation unit at a first location. The converting includes removing oil production equipment, coupling two hydrocarbon producing units, and installing a crane. The method further includes transporting the wind turbine installation unit to a second location, and installing a wind turbine at the second location using the crane on the wind turbine installation unit.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1 a perspective view of an exemplary jack-up rig.

FIG. 2A is an elevation view of a converted jack-up rig according to one embodiment.

FIG. 2B is a plan view of the jack-up rig of FIG. 2A.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to movable offshore platforms for installing wind turbines, and methods of forming the same. The movable offshore platforms are offshore platforms which were previously used in hydrocarbon production, such as jack-up units. The movable offshore platforms may be decommissioned and retrofitted with equipment for installing wind turbines. The movable offshore platforms may be American-made or otherwise Jones Act compliant. Methods of forming the same are also included.

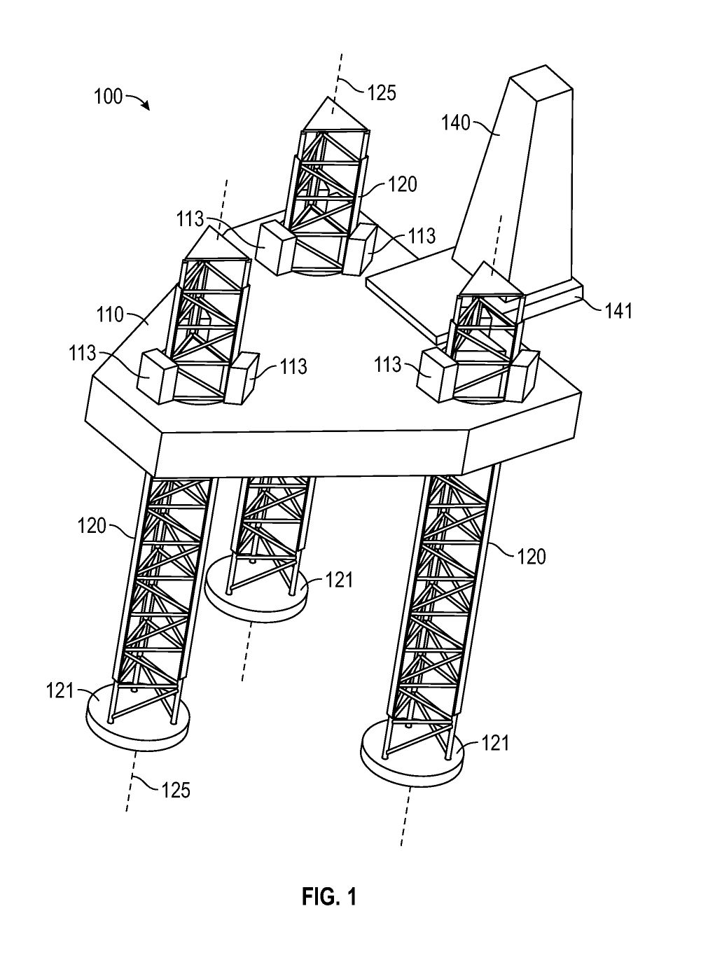

FIG. 1 is a perspective view of an exemplary jack-up rig 100. In general, the jack-up rig 100 is a structure designed for offshore drilling operations for hydrocarbon production. The jack-up rig 100 includes a buoyant hull 110, a plurality of support legs 120 movably coupled to hull 110, and drilling equipment, such as a derrick 140, supported by the hull 110. The derrick 140 may be positioned on a derrick support structure such as a cantilever 141 to facilitate horizontal movement of the derrick 140. The derrick 140 may also be positioned on a substructure. The jack-up rig 100 is alternatively referred to herein as moveable hydrocarbon producing unit.

Each leg 120 is moveably coupled to the hull 110 such that each leg 120 may be independently and controllably moved axially upward and downward relative to the hull 110 along an axis 125 by jacks 113. The legs 120 are configured to raise and lower the jack-up rig 100 to and from the surface of the sea for transportation and operation. Spud cans 121 are coupled to an end of each leg 120. Here, the jack-up rig 100 is illustrated as having three legs 120. However, any suitable number of legs 120 may be utilized, such as four or more legs 120.

In one example, the jack-up rig 100 may be an American-made offshore platform to comply with The Marine Merchant Act of 1920 (e.g., the Jones Act). Compliance with the Jones Act facilitates ease of maintenance by providing American-crewed vessels access to the jack-up rig 100 for retrofitting and maintenance. Additionally, the jack-up rig 100 may be towed into a United States port for maintenance or for protection from inclement weather. However, other vessels may also benefit from aspects of the disclosure. For example, American made vessels that are not compliant with the Jones Act or even vessels not made in America could be utilized herewith.

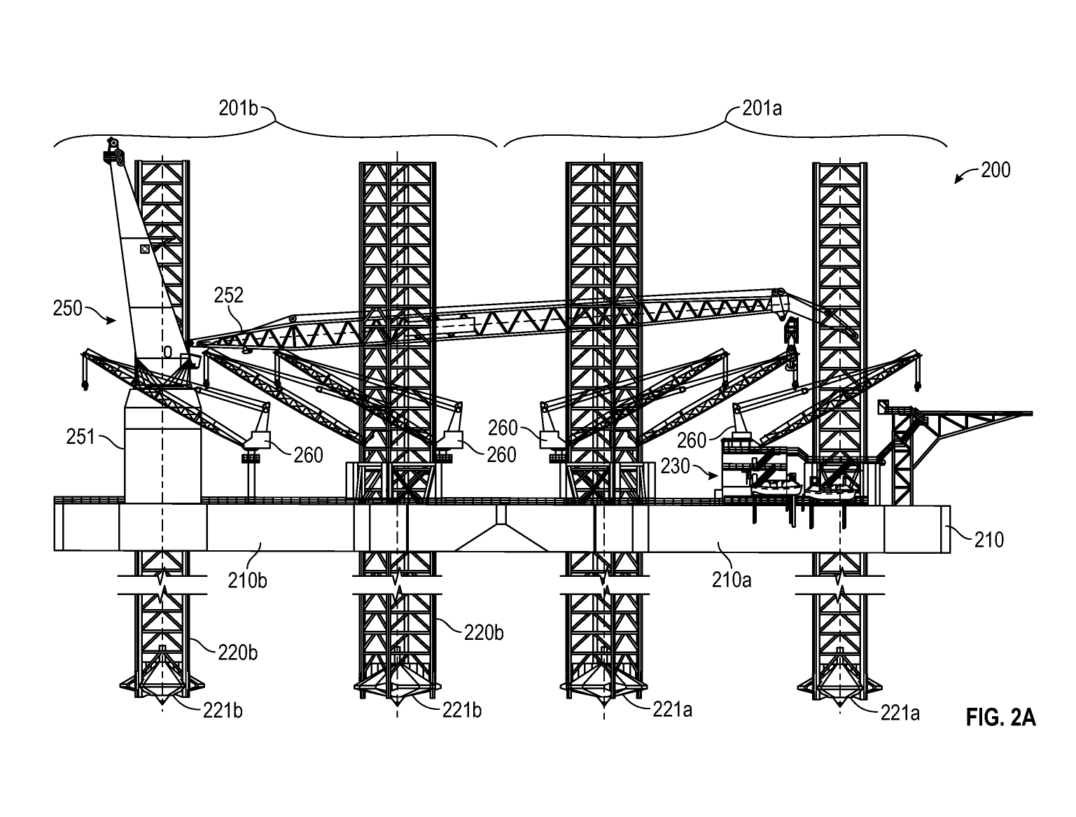

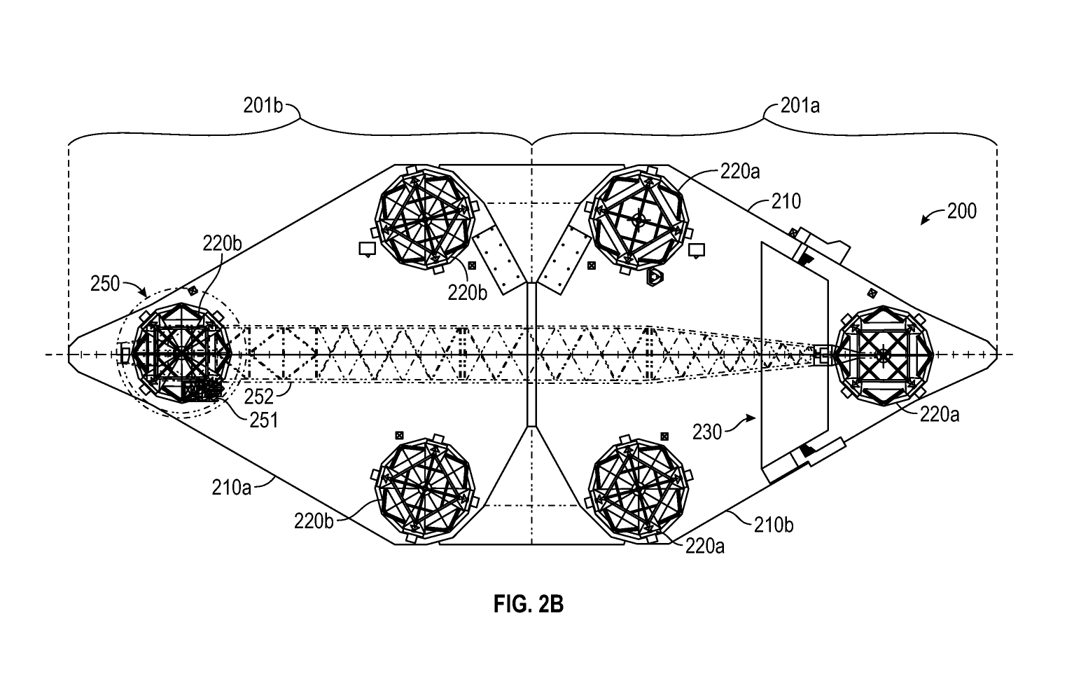

FIG. 2A is an elevation view of a converted jack-up rig 200 made from two decommissioned jack-ups rigs 201a, 201b for installation of wind turbines. The jack-up rigs 201a, 201b may be like the jack-ups rigs 100 after decommissioning as discussed below, or another configuration of jack-up rig. FIG. 2B is a plan view of the modified jack-up rig 200. The drilling and oil production equipment, such as the derrick 140 and the cantilever 141, has been removed from the jack-up rigs 201a, 201b prior to coupling the jack-up rigs 201a, 201b together to form the jack-up rig 200. Here, the jack-up rig 200 has a buoyant hull 210 formed made from the adjoining hulls 210a, 210b of the jack-up rigs 201a, 201b. Here, six legs 220a, 220b extend through the hull 210 and have spud cans 221a, 221b coupled respectively thereto. Again, another number of jack-up legs 200 may be used herewith. Additionally, the jack-up legs 200 may be coupled to a periphery of the hull 210 rather than extending therethrough.

Upon decommissioning, a movable hydrocarbon production platform, such as the jack-up rig 100, generally has the hydrocarbon production equipment, such as the cantilever 141 and the derrick 140, removed therefrom. In one example, the cantilever 141 and the derrick 140 are removed via a vessel (not shown) which may be positioned adjacent to the jack-up rig 100 in sufficient range to allow a crane on the vessel to remove the cantilever 141 and the derrick 140. The cantilever 141 and the derrick 140 may be positioned on another vessel for transportation. The moveable hydrocarbon producing unit (i.e., jack-up rig 100) may be left at sea and unmaintained, or may be brought back to shore, but regardless, the useful life of the jack-up rig 100 is largely concluded regarding hydrocarbon production. However, in accordance with the present disclosure, the jack-up rig 100 may be reconfigured to install wind turbines on a sea bed. Thus, the reconfigured or retrofitted jack-up rig is capable of facilitating generation of green energy, and has a useful life extending far beyond that of hydrocarbon production.

A heavy lift crane 250 is installed on the jack-up vessel 200. The heavy lift crane 250 includes a base 251 and a boom 252. The base 251 defines a vertical axis of rotation for the boom 252 to rotate thereabout. The base 251 includes a bearing, a track, or another device on which the boom 252 rotates. The boom 252 is further pivotable about a horizontal axis defined at the coupling point between the boom 252 and the base 251 thereby allowing the boom 252 to be raised and lowered in a vertical plane. The heavy lift crane 250 is a crane with sufficient height and lifting ability to position a load of a desired size, such as wind turbine, on a seabed. For example, the heavy lift crane 250 may be a 600 ton to 2000 ton crane.

In one example, the pedestal 251 is coupled to the hull 210 surrounding one of the legs 220b. In this configuration, the leg 220b is free to actuate vertically while the crane 250 can rotate thereabout. It is understood that the crane 250 can be coupled to the hull 210 in a different configuration, such as surrounding a different leg 220a or coupled to the hull 210 at a different location. The jack-up rig 200 optionally includes one or more auxiliary cranes 260. One or more auxiliary cranes 260 are optionally disposed at different locations around the hull 210 for lifting or support of various operations of the jack-up rig 200.

A superstructure 230 is installed on the hull 210. The superstructure 230 may include quarters for housing crew members, storage for consumable supplies, a control room, and a helipad, among other facilities. The superstructure 230 may be part of the jack-up rigs 201a, 201b prior to decommissioning or may be retrofitted thereto as part of the jack-up rig conversion. In one example, the superstructure 230 is an existing structure that is modified as needed to suit the needs of the jack-up vessel 200.

In one example, the jack-up rig 200 is a wind turbine installation unit which may be towed to desired locations to install offshore wind turbines. One or more wind turbines or wind turbine components, such as foundations, and corresponding support posts may be stored on the jack-up rig 200 during transportation to a desired offshore site. The support posts may be stored in a vertical or a horizontal configuration. Alternatively, the wind turbines and support posts may be stored on other vessels. The jack-up rig 200 can be positioned at the desire location to install one or more wind turbines and respective foundations and then moved to a new positon at the same offshore field or a new location for further operations.

Conversion of decommissioned hydrocarbon-producing offshore installations to wind turbine installation units provides a significant “green” impact on the environment by using resources which are otherwise left in disrepair. Moreover, by selecting American-made movable platforms, the converted platforms are Jones Act compliant, and therefore can be serviced by United States ships and crews, and can be brought to United States ports for maintenance or to avoid inclement weather. The movable offshore platforms disclosed herein can be moved from location-to-location to install offshore wind turbines at multiple locations. Using movable offshore platforms, rather than ships or other vessels, provides a sturdier and more secure base for crane operations, and thus, not only are the disclosed movable offshore platform safer, but also allow installation of larger wind turbines. The wind turbine installation units described herein further benefit from a large deck area for transporting of larger wind turbines that are currently under design. Still further, the adjoining of two movable platforms allows for easy expansion of the deck in subsequent future modifications if the need arises.

The disclosure is not limited to wind turbine installation. Other offshore construction and decommissioning operations could be undertaken using the jack-up vessel. Additionally, the jack-up rig 200 may also be used to decommission other offshore platforms. In one example, the jack-up rig 200 can be positioned adjacent to a platform to be decommissioned. The jack-up rig 200 may store decommissioned components, such as a derrick or other structural members, and can further transport the decommissioned components to shore for final disposal. The large deck space of the jack-up rig 200 increases the size of components that are able to be transported to shore where more cost effective decommissioning can be carried out.

While the foregoing is directed to embodiments of the present disclosure, other and further embodiments of the disclosure may be devised without departing from the basic scope thereof, and the scope thereof is determined by the claims that follow.

What is claimed is:

1. A method converting a movable offshore platform to a wind turbine installation unit, comprising:
converting a moveable hydrocarbon producing unit, the converting comprising removing oil production equipment;
coupling the two moveable hydrocarbon producing units to form a hull; and
installing a heavy lift crane on the hull

2. The method of claim 1, wherein the moveable hydrocarbon producing units are American made and is Jones Act compliant.

3. The method of claim 1, wherein the oil production equipment includes a derrick and derrick support structure.

4. The method of claim 1, wherein moveable hydrocarbon producing units are jack-up rigs.

5. The method of claim 4, wherein each of the moveable hydrocarbon producing units prior to conversion includes a buoyant hull, a plurality of support legs movably coupled to the buoyant hull, and a derrick supported by the hull.

6. The method of claim 5, wherein the converting comprises removing the derrick.

7. The method of claim 1, wherein the each of the moveable hydrocarbon producing units includes a cantilever on which a derrick is mounted, and wherein the converting comprises removing the cantilever and the derrick.

8. The method of claim 7, wherein the converting comprises:
positioning a vessel having a crane thereon adjacent to the movable hydrocarbon producing unit;
removing the cantilever and the derrick with the crane of the vessel; and
positioning the cantilever and the derrick on the vessel.

9. The method of claim 7, wherein the crane is a heavy lift crane on a rotatable base, the heavy lift crane configured to lift 600 tons to 2000 tons.

10. The method of claim 1, wherein the moveable hydrocarbon producing units are decommissioned prior to conversion.

11. A movable offshore platform made according to the method of claim 1.

12. A wind turbine installation method, comprising:
converting a hydrocarbon producing unit to a wind turbine installation unit at a first location, the converting including removing oil production equipment from the hydrocarbon producing unit, coupling two hydrocarbon producing units, and installing a crane;
transporting the wind turbine installation unit platform to a second location; and
installing a wind turbine at the second location using the crane on the wind turbine installation unit.

13. The method of claim 12, wherein the wind turbine installation unit is American made and is Jones Act compliant.

14. The method of claim 12, wherein the converting includes removing a derrick and derrick support structure.

15. The method of claim 12, wherein the hydrocarbon producing unit is a jack-up rig.

16. The method of claim 12, wherein the jack-up rig prior to conversion includes a buoyant hull, a plurality of support legs movably coupled to the buoyant hull, and a derrick supported by the hull.

17. The method of claim 16, wherein the converting comprises removing the derrick.

18. The method of claim 12, wherein the hydrocarbon producing unit includes a cantilever on which a derrick is mounted, and wherein the converting comprises removing the cantilever and the derrick.

19. The method of claim 7, wherein the converting comprises:
positioning a vessel having a crane thereon adjacent to hydrocarbon producing unit;
removing the cantilever and the derrick with the crane of the vessel; and
positioning the cantilever and the derrick on the vessel.

20. The method of claim 12, wherein the hydrocarbon producing unit is decommissioned prior to conversion.
